(19) United States
(12) Patent Application Publication
(10) Pub. No.: US 2013/0334307 A1
(43) Pub. Date: Dec. 19, 2013

(54) SYSTEMS AND METHODS FOR MAINTAINING ORDER OF INDIVIDUALS IN A PUBLIC TRANSPORTATION QUEUE

(71) Applicant: Yat Wai Edwin Kwong, Causeway Bay (HK)

(72) Inventor: Yat Wai Edwin Kwong, Causeway Bay (HK)

(21) Appl. No.: 13/523,883

(22) Filed: Jun. 15, 2012

(51) Int. Cl. G06K 5/00

(52) U.S. Cl. 235/382

(57) ABSTRACT

Systems and methods for facilitating and maintaining orderly queuing and boarding of a public transportation vehicle are provided. The system and method generally employ a smart card reader placed at a public transportation vehicle stop (e.g. a bus stop). Each passenger, upon arriving at the stop before the vehicle has, presents a smart card to the card reader in order to secure a position in the queue for the vehicle. When it comes time to board the vehicle, the passengers must board in order according to their assigned position. Enforcement of such may involve the passenger presenting their smart card another time before boarding. If the passenger's position has been reached in the queue, the passenger shall be permitted to board. Otherwise, the passenger is denied entry to the vehicle. The system and method may further comprise a camera and/or a second card reader placed in the vehicle.

### FIELD OF THE INVENTION

This invention is generally related to public transportation systems. More specifically, this invention is related to the facilitation of orderly queuing lines for individuals waiting to ride a mode of public transport.

### BACKGROUND OF THE INVENTION

As cities become more and more overcrowded, a heavier load is placed upon a city's infrastructure. Traffic and congestion in cities has led to increasingly more people relying on different modes of public transportation in order to get where they need to go. Smart card or smart pass systems have sprung up in many cities in order to facilitate expedited admission to buses, trains, streetcars, trams and light-rails. These systems employ cards or passes that are carried by commuters. The cards have an associated balance that can be used to pay a fare. The balance may be increased remotely or at kiosks near the location of the transportation.

However, the public transportation systems in some cities just cannot handle the ever-growing number of people choosing to commute to via public transportation. Thus, during periods of rush hour, lines or queues of awaiting passengers begin to form at public transport vehicle stops long before the vehicle is due to arrive. Inevitably conflict often arises between passengers over the order of the queue. Thus, there is a need for a system that facilitates smooth and orderly boarding of a public transportation vehicle during times of increased passenger load.

In view of the foregoing, there is a need for a system and method for maintaining an orderly queue at a public transport vehicle stop.

### SUMMARY OF THE INVENTION

According to embodiments of the invention, a system for maintaining order in a public transportation queue is provided. The system's components are: a plurality of smart cards, a smart card reader placed at a public transport vehicle stop, a counter associated with the smart card reader, a smart card reader in the public transport vehicle, a camera, a processor, and a memory. Each smart card of the plurality of smart cards is associated with an individual and comprises a balance used to pay for a fare. The smart card reader registers a particular individual into the queue when the particular individual touches their smart card against the smart card reader. Each individual who is registered will be assigned a number in ascending order by the counter. The smart card reader in the vehicles handles the fares and confirms the order of the queue is followed. The camera is placed at the public transport vehicle stop and is configured to capture a face of an individual when that individual touches his or her smart card against the smart card reader. The camera re-captures an image of the face just prior to boarding in order to confirm identity.

The memory stores instructions that cause the processor to execute a method. The method generally employs the following steps, in no specific or particular order.

The method begins by detecting whether a given individual wrongfully moves up in the queue. The second step involves detecting whether the given individual tries to line up on behalf of another individual. The third step involves detecting whether the given individual tries to join someone who has already registered. Then finally, the method detects whether the given individual attempts registering more than one time.

For the purposes of this specification, a “public transportation vehicle” may be any mode of transportation available and utilized by two or more public passengers. Such modes of transportation may include buses, vans, trains, streetcars, trams, light rails, and trolleys. It is contemplated that the disclosed invention may be used in conjunction with private or semi-private means of transportation that may be accessible by the general public. The term “public”, when referred to in the specification in the claims is not meant to be limiting, and is taken to mean any mode of transport that is accessible by two or more “non-acquaintances” or members of the public. Thus, the disclosed invention may be used in conjunction with passenger airlines as well. Several airlines have recently introduced unassigned seating on certain flights. This system and method would be applicable to such flights because boarding can become rather daunting given the preference to certain seats in an airplane.

In another embodiment of the disclosed invention, a system for maintaining order in a public transportation queue is provided. The system's components are: a plurality of smart cards, a first smart card reader placed at a public transport vehicle stop, a counter associated with the smart card reader, a second smart card reader placed in the public transport vehicle, a camera, a processor, and a memory. Each smart card of the plurality of smart cards is associated with an individual and comprises a balance used to pay for a fare.

The first smart card reader registers a particular individual into the queue when the particular individual touches their smart card against the smart card reader. Each individual who is registered will be assigned a number in ascending order by the counter. The second smart card reader in the vehicles handles the fares and confirms the order of the queue is followed. The second smart card reader is in electrical or wireless communication with the first smart card reader. Data is capable of being transmitted between the two smart card readers. The second smart card reader operates to confirm that the order of the queue is followed when passengers board or are about to board the transportation vehicle.

In further embodiments of this system, a camera may be provided. The camera is placed at the public transport vehicle stop and is configured to capture a face of an individual when that individual touches his or her smart card against the smart card reader. The camera re-captures an image of the face just prior to boarding in order to confirm identity.

In still further embodiments of this system, a processor and a memory are provided. The memory stores instructions that cause the processor to execute a method. The method generally employs the following steps, in no specific or particular order.

The method begins by detecting whether an ordered number has been assigned to a given individual by the counter. If the counter has yet to assign the ordered number, then system concludes that the given individual has boarded out of order.

The second step is directed to detecting whether the given individual tries to line up on behalf of another individual. This step involves determining whether a captured photo taken during registration of the queue matches the face of the given individual. If the captured photo is different, then the system concludes that the given individual has boarded out of order.

The third step involves detecting whether the given individual tries to join someone who has already registered. The detection includes determining whether an ordered number has been assigned by the counter. If no ordered number has been assigned, the system concludes that the given individual has boarded out of order. A further step may be included of alerting the bus driver to eject the given individual if the given individual is concluded to have boarded out of order.

In still another embodiment of the disclosed invention, a method for facilitating entry onto a public transportation vehicle is provided. The method employs the following steps. The first step is directed to providing a plurality of smart cards. Each smart card has a unique identifier with an associated fare balance. The smart cards may be provided to passengers who pay for the cards or load money onto the cards. The second step involves providing a smart card reader at a stop of the public transportation vehicle. The third step is directed to receiving, to the smart card reader, a unique identifier from a first smart card of the plurality of smart cards. The unique identifier may be received by way of radio-frequency (“rf”) communication or a magnetic stripe on the card. Upon receiving the unique identifier the smart card reader registers the first smart card in the queue. Then, the smart card reader assigns a number to the first smart card based on a number of smart cards already registered. Thus, the user has reserved his/her spot in “line” and does not have to stand in line in order to keep the spot.

In further embodiments of this method, an additional step may be provided of requiring the first smart card to be presented again when the number assigned to the first smart card is displayed upon boarding of the public transportation vehicle. This step may be carried out via a second smart card reader placed inside the public transportation vehicle or by the original smart card reader located at the public transportation vehicle stop. In still a further embodiment, a user carrying the first smart card may be refused entry onto the public transportation vehicle if the first smart card is presented before the assigned number is displayed. This would mean that the user has attempted to “cut” or move up in the line.

It is, therefore, an objective of the disclosed invention to provide a system and method for maintaining order in a public transportation queue.

In accordance with these and other objects which will become apparent hereinafter, the invention will now be described with particular reference to the drawing.

### BRIEF DESCRIPTION OF THE DRAWINGS

FIG. 1 is a side elevation view of a system according to an embodiment of the present invention.

FIG. 2 is a high-level block diagram of a smart card reader that may be used to carry out the disclosed technology.

### DETAILED DESCRIPTION

Referring now to the figures, a system and method for facilitating and maintaining orderly queuing and boarding of a public transportation vehicle are is provided. The system and method generally employs a smart card reader placed at a public transportation vehicle stop (e.g. a bus stop). Each passenger, upon arriving at the stop before the vehicle has, presents a smart card to the card reader in order to secure a position in the queue for the vehicle. When it comes time to board the vehicle, the passengers must board in order according to their assigned position. Enforcement of such may involve the passenger presenting their smart card another time before boarding. If the passenger's position has been reached in the queue, the passenger shall be permitted to board. Otherwise, the passenger may be denied entry to the vehicle. The system and method may further comprise a camera and/or a second card reader placed in the vehicle. The purpose of the system and method is to prevent passengers from moving up or “cutting” in line and holding spots in line for others. In doing so, potential conflicts amongst passengers are avoided and the efficiency of the boarding process is increased.

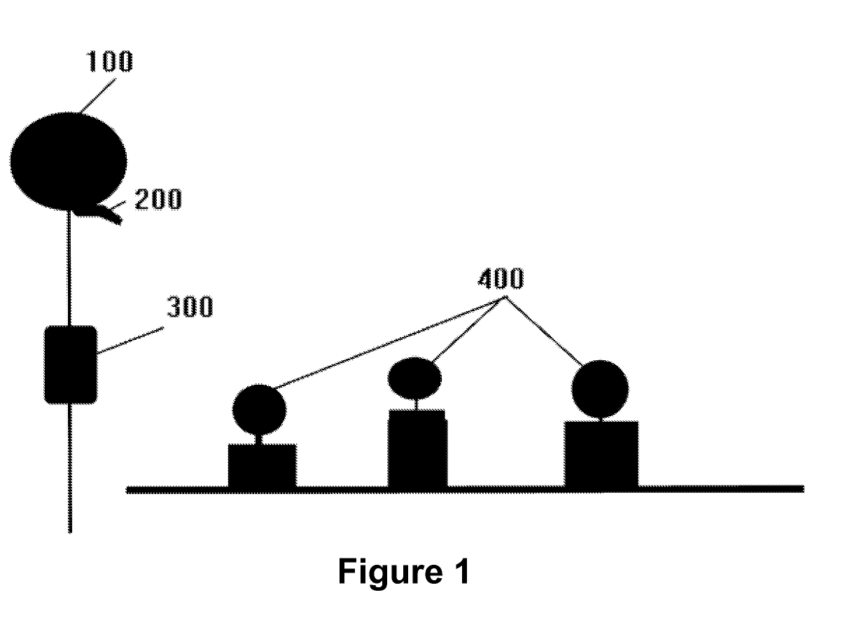

Referring now to FIG. 1, a side elevation view of a system according to an embodiment of the present invention is shown. The system facilitates the orderly boarding of a public transport vehicle by two or more passengers or individuals 400 waiting at a public transport stop 100. The systems components include: a plurality of smart cards, a smart card reader 300 placed at a public transport vehicle stop 100, a counter associated with the smart card reader, a smart card reader in the public transport vehicle, a camera 200, a processor, and a memory. Each smart card of the plurality of smart cards is associated with an individual of a plurality of individuals 400. The smart card comprises a balance used to pay for a fare. The smart card reader 300 registers a particular individual into the queue when the particular individual touches their smart card against the smart card reader 300. Each individual who is registered will be assigned a number in ascending order by the counter. The smart card reader in the vehicles handles the fares and confirms the order of the queue is followed. The camera 200 is placed at the public transport vehicle stop and is configured to capture a face of an individual when that individual touches his or her smart card against the smart card reader. The camera 200 re-captures an image of the face just prior to boarding in order to confirm identity.

The memory stores instructions that cause the processor to execute a method. The method generally employs the following steps, in no specific or particular order.

The method begins by detecting whether a given individual wrongfully moves up in the queue. The second step involves detecting whether the given individual tries to line up on behalf of another individual. The third step involves detecting whether the given individual tries to join someone who has already registered. Then finally, the method detects whether the given individual attempts registering more than one time.

In another embodiment of the disclosed invention, a system for maintaining order in a public transportation queue is provided. The systems components are: a plurality of smart cards, a first smart card 300 reader placed at a public transport vehicle stop 100, a counter associated with the smart card reader, a second smart card reader placed in the public transport vehicle, a camera 200, a processor, and a memory. Each smart card of the plurality of smart cards is associated with an individual and comprises a balance used to pay for a fare.

The first smart card reader registers a particular individual into the queue when the particular individual touches their smart card against the smart card reader 300. Each individual who is registered will be assigned a number in ascending order by the counter. The second smart card reader in the vehicles handles the fares and confirms the order of the queue is followed. The second smart card reader is in electrical or wireless communication with the first smart card reader 300. Data is capable of being transmitted between the two smart card readers. The second smart card reader operates to confirm that the order of the queue is followed when passengers board or are about to board the transportation vehicle.

In further embodiments of this system, a camera 200 may be provided. The camera 200 is placed at the public transport vehicle stop and is configured to capture a face of an individual when that individual touches his or her smart card against the smart card reader 300. The camera 200 re-captures an image of the face just prior to boarding in order to confirm identity.

In still further embodiments of this system, a processor and a memory are provided. The memory stores instructions that cause the processor to execute a method. The method generally employs the following steps, in no specific or particular order.

The method begins by detecting whether an ordered number has been assigned to a given individual by the counter. If the counter has yet to assign the ordered number, then system concludes that the given individual has boarded out of order.

The second step is directed to detecting whether the given individual tries to line up on behalf of another individual. This step involves determining whether a captured photo taken during registration of the queue matches the face of the given individual. If the captured photo is different, then the system concludes that the given individual has boarded out of order.

The third step involves detecting whether the given individual tries to join someone who has already registered. The detection includes determining whether an ordered number has been assigned by the counter. If no ordered number has been assigned, the system concludes that the given individual has boarded out of order. A further step may be included of alerting the bus driver to eject the given individual if the given individual is concluded to have boarded out of order.

In still another embodiment of the disclosed invention, a method for facilitating entry onto a public transportation vehicle is provided. The method employs the following steps. The first step is directed to providing a plurality of smart cards. Each smart card has a unique identifier with an associated fare balance. The smart cards may be provided to passengers 400 who pay for the cards or load money onto the cards. The second step involves providing a smart card reader 300 at a stop 100 of the public transportation vehicle. The third step is directed to receiving, to the smart card reader 300, a unique identifier from a first smart card of the plurality of smart cards. The unique identifier may be received by way of radio-frequency (“rf”) communication or a magnetic stripe on the card. Upon receiving the unique identifier the smart card reader 300 registers the first smart card in the queue. Then, the smart card reader 300 assigns a number to the first smart card based on a number of smart cards already registered. Thus, the user has reserved his/her spot in “line” and does not have to stand in line in order to keep the spot.

In further embodiments of this method, an additional step may be provided of requiring the first smart card to be presented again when the number assigned to the first smart card is displayed upon boarding of the public transportation vehicle. This step may be carried out via a second smart card reader placed inside the public transportation vehicle or by the original smart card reader 300 located at the public transportation vehicle stop 100. In still a further embodiment, a user carrying the first smart card may be refused entry onto the public transportation vehicle if the first smart card is presented before the assigned number is displayed. This would mean that the user has attempted to “cut” or move up in the line. The rejection of the individual may be carried out by an automated turnstile becoming locked or by a notification to a driver of the public transport vehicle.

Embodiments of the disclosed technology may be carried out using radio frequency identification (“rfid”) technology. Rfid tagging is a known method of identification. An information carrying device, or tag, functions in response to a coded radio frequency (“rf”) signal transmitted from a base station or reader. The rf carrier signal reflects from the tag and can be demodulated to recover information stored in the tag. The tag typically includes a semiconductor chip having rf circuits, logic, and memory, as well as an antenna. Various tag structures, circuits, and programming protocols are known in the art.

Most rf systems typically have three components: (1) a tag or tag (the item being identified), (2) an interrogator or reader, and (3) a data managing medium (typically including cabling, computers, and software which tie together the tags and interrogators into a useful solution). Most rf products are typically designed to detect tags when they pass within a predefined range of the reader.

There are generally two types of rf tags known in the art: passive rf tags and active rf tags. Passive rf tags, unlike active ones, do not require a battery in order to transmit a rf signal frequency. Instead, passive rf tags rely on an external source to provoke signal transmission. The rf reader transmits the operating power for these tags. As a result, such passive rf systems generally have a detection range of limited to a couple meters. However, passive rf tags may generally be manufactured to be smaller in size than active rf tags due to the absence of a battery.

Most passive rfid systems work as follows. A reader emits an electromagnetic field for the purpose of powering the tag. A coil in the tag is powered by the electromagnetic field, causing the tag's circuitry to “wake up.” The tag uses this power to send an identifying signal back to the interrogator.

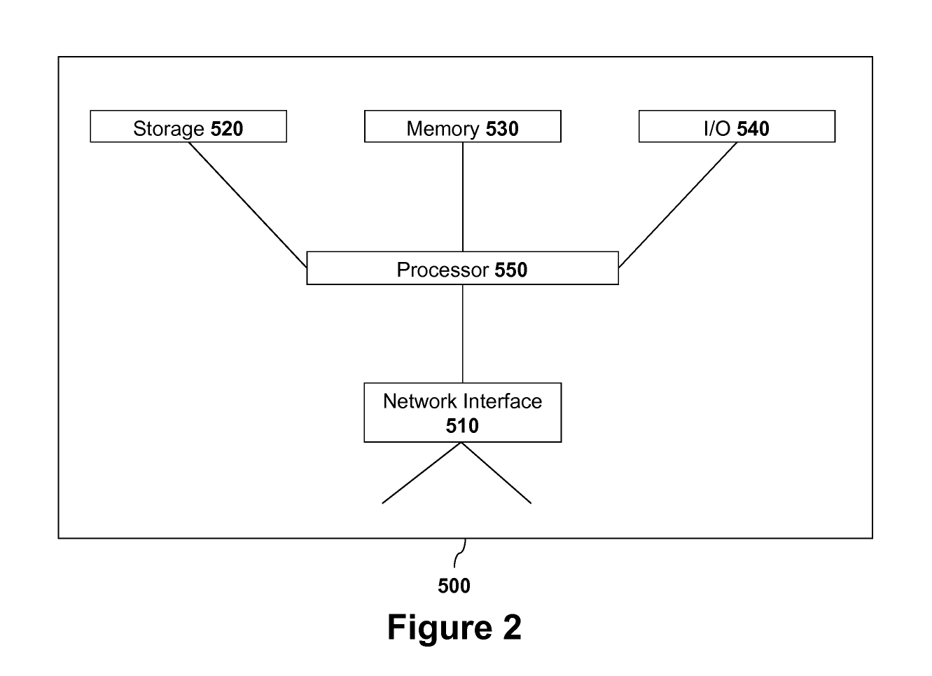

FIG. 2 is a high-level block diagram of a smart card reader that may be used to carry out the disclosed technology. The Smart card reader 500 may be or may be electrically connected to a computer. The smart card reader 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the reader's 500 operation will be defined by the smart card's program instructions stored in memory 530 and/or storage 520, and the console will be controlled by processor 550 executing the console's program instructions. The smart card reader 500 may also include one or a plurality of input network interfaces for communicating with other devices via a network (e.g., the internet). The smart card reader 500 further includes an electrical input interface for receiving power and data from a power or RFID source. A smart card reader 500 also includes one or more output network interfaces 510 for communicating with other devices. The smart card reader 500 may also include input/output 540 representing devices which allow for user interaction with a computer (e.g., display, keyboard, mouse, speakers, buttons, etc.). One skilled in the art will recognize that an implementation of an actual device will contain other components as well, and that FIG. 2 is a high level representation of some of the components of such a device for illustrative purposes. It should also be understood by one skilled in the art that the method and devices depicted in FIG. 1 may be implemented on a device such as is shown in FIG. 2.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A system for maintaining order in a public transportation queue, comprising:
a plurality of smart cards, wherein each smart card is associated with an individual, and further wherein each smart card comprises a balance used to pay a fare;
a smart card reader placed at a public transport vehicle stop, wherein the smart card reader registers a particular individual into the queue when the particular individual touches their smart card against the smart card reader;
a counter associated with the smart card reader, wherein each individual who is registered will be assigned a number in ascending order;
a smart card reader in the public transport vehicle, wherein the smart card reader handles the fares, and further wherein the smart card reader confirms that the order of the queue is followed;
a camera at the public transport vehicle stop configured to capture a face of the particular individual when the particular individual touches their smart card against the smart card reader and re-capture the face of the particular individual to confirm identity of the particular individual when the particular individual boards the public transport vehicle;
a processor; and
a memory storing instructions that cause the processor to execute a method, the method comprising:
detecting whether a given individual wrongfully moves up in the queue;
detecting whether the given individual tries to line up on behalf of another individual;
detecting whether the given individual tries to join another individual who has already registered; and
detecting whether the given individual attempts registering more than one time.

2. A system for maintaining order in a public transportation queue, comprising:
a plurality of smart cards, wherein each smart card is associated with an individual and further wherein each smart card comprises a balance used to pay a fare;
a first smart card reader placed at a public transport vehicle stop, wherein the smart card reader registers individuals into the queue as each individual touches their smart card against the smart card reader;
a counter associated with the smart card reader, wherein each individual who is registered will be assigned a number in ascending order; and
a second smart card reader in the public transport vehicle that is in communication with the first smart card reader, wherein the second smart card reader handles the fares and further wherein the second smart card reader confirms that the order of the queue is followed.

3. The system of claim 2, wherein the first smart card reader comprises a camera configured to:
capture a face of each individual upon registration; and re-capture the face of each individual to confirm identity of each individual when boarding the public transport vehicle.

4. The system of claim 3, further comprising:
a processor; and
a memory storing instructions that cause the processor to execute a method, the method comprising:
detecting whether a given individual wrongfully moves up in the queue by:
using the second smart card reader to determine whether a number has been assigned by the counter; and
if the counter has yet to assign the ordered number, concluding that the given individual has boarded out of order;
detecting whether the given individual tries to line up on behalf of another individual, wherein the detection includes:
determining whether a captured photo taken during registration of the queue matches the face of the given individual; and
if the captured photo is different, concluding that the given individual has boarded out of order; and
detecting whether the given individual tries to join someone who is already registered, wherein the detection includes determining whether a number has been assigned by the counter; and if no ordered number has been assigned, concluding that the given individual has boarded out of order.

5. The system of claim 4, wherein if the given individual is concluded to have boarded out of order, a driver of the public transport vehicle is alerted to eject the given individual.

6. A method for facilitating entry onto a public transportation vehicle comprising the following steps:
providing a plurality of smart cards wherein each smart card comprises a unique identifier with an associated fare balance;
providing a smart card reader at a stop of the public transportation vehicle;
receiving, to the smart card reader, a unique identifier from a first smart card of the plurality of smart cards;
registering the first smart card; and
assigning a number to the first smart card based on a number of smart cards already registered.

7. The method of claim 6, further comprising a step of requiring the first smart card to be presented again when the number assigned to the first smart card is displayed upon boarding of the public transportation vehicle.

8. The method of claim 7, wherein the step of requiring the first smart card to be presented is carried out via a second smart card reader placed inside the public transportation vehicle.

9. The method of claim 8, wherein a user carrying the first smart card is refused entry onto the public transportation vehicle if the first smart card is presented before the assigned number is displayed.

10. The method of claim 7, wherein a user carrying the first smart card is refused entry onto the public transportation vehicle if the first smart card is presented before the assigned number is displayed.
